(19) United States
(12) Patent Application Publication
(10) Pub. No.: US 2023/0379993 A1
(43) Pub. Date: Nov. 23, 2023

(54) Method for Establishing Association of Multi-link Device, Electronic Device, and Storage Medium

(71) Applicant: Yibin XGIMI Optoelectronic Co.,Ltd, Yibin (CN)

(72) Inventors: Hao WU, Chengdu (CN); Lei YIN, Chengdu (CN)

(21) Appl. No.: 18/130,438

(22) Filed: Apr. 4, 2023

(30) Foreign Application Priority Data
May 20, 2022 (CN) 202210550585.9

(51) Int. Cl. H04W 76/15; H04W 52/02

(52) U.S. Cl. CPC H04W 76/15; H04W 52/0235

(57) ABSTRACT

The embodiments of the disclosure disclose a method for establishing an association of a multi-link device, a electronic device, and a storage medium. The method includes: a higher layer management entity of a first multi-link device determines that a device required to be associated is a second multi-link device, and sends a multi-link association request primitive to a lower layer management entity, the primitive includes an address of the second multi-link device, and information of at least two groups of links requesting to establish an association, the information of the links requesting to establish an association includes identifiers of the links requesting to establish an association, and association modes corresponding to the links, and association modes corresponding to links requesting to establish an association are set as active modes, which the links requesting to establish an association are included in information of at least one group of links requesting to establish an association; and the lower layer management entity establishes an association with the second multi-link device according to the multi-link association request primitive.

### TECHNICAL FIELD

The disclosure relates to the field of radio communication, and in particular to a method for establishing an association of a multi-link device, an electronic device, and a non-transitory computer-readable storage medium.

### BACKGROUND

In the 802.11 system, stations (such as an access point station (AP STA) and a non-access point station (Non-AP STA)) are each internally provided with a media access control (MAC) layer and a physical (PHY) layer. The MAC layer is mainly configured for channel management, association management, quality of service management, power control, time synchronization, etc., and the PHY layer is mainly configured for modulation, coding, transmission, etc.

Conceptually, the MAC layer and the PHY layer each include management entities called an MAC sublayer management entity (MLME) and a PHY sublayer management entity (PLME), respectively. These entities can be called lower layer management entities, which provide lower layer management service interfaces, so as to invoke lower layer management functions.

In order to provide correct MAC operations, both stations (including Non-AP STA and AP STA) have each a higher layer management entity, such as a station management entity (SME). The SME represents a higher layer management entity above the MAC layer and independent of the layer, and is positioned in a separate management plane.

Commonly, the SME is responsible for collecting sublayer-related modes, etc. from various sublayer management entities (MLME and PLME). Similarly, the SME also sets layer-specific parameters. Typically, the SME executes such functions on behalf of the general system management entity. The sublayers interact with each other through defined primitives. FIG. 1 describes a relation between the management entities.

The 802.11be system, also called an extremely high throughput (EHT) system, realizes extremely high throughput through a series of system features and a variety of mechanism enhancement functions. With the wireless local area network (WLAN) increasingly popularized, it is of increasing importance to provide wireless data services in numerous environments, such as homes, businesses, and hotspots. Particularly, video traffic will continue being a dominant traffic type in a number of WLAN deployments. In the presence of videos of 4 k and 8 k (at an uncompressed rate of 20 Gbps), the throughput required by these applications is evolving. The novel high-throughput and low-delay applications such as virtual reality or augmented reality, games, remote offices, and cloud computation will proliferate (for example, a real-time game has a delay less than 5 ms).

In view of the high throughput and stringent real-time delay requirements of these applications, users expect higher throughput, higher reliability, less delay and jitter, and higher power efficiency when their applications are supported over WLAN. Users expect improved integration with a time-sensitive network (TSN), so as to support applications on heterogeneous Ethernet and wireless LAN. The 802.11be network is intended to ensure both the competitiveness of WLAN by further improving overall throughput and reducing a delay, and backward compatibility and coexistence with older technical standards. The 802.11 compatible device operates in bands of 2.4 GHz, 5 GHz, and 6 GHz.

### SUMMARY

In a first aspect, the embodiments of the disclosure provide a method for establishing an association of a multi-link device. The method is applied to a first multi-link device, the first multi-link device includes a higher layer management entity and a lower layer management entity. The method includes:
the higher layer management entity determines that a device required to be associated is a second multi-link device;
the higher layer management entity sends a multi-link association request primitive to the lower layer management entity, the multi-link association request primitive includes an address of the second multi-link device requesting to establish an association, and information of at least two groups of links requesting to establish an association, the information of the links requesting to establish an association includes identifiers of the links requesting to establish an association, and corresponding association modes, the association modes include an active mode and a sleep mode, the active mode indicates that the link may perform data transmission, the sleep mode indicates that the link may not perform data transmission, and association modes corresponding to links requesting to establish an association are set as active modes, wherein the links requesting to establish an association are included in information of at least one group of links requesting to establish an association in the multi-link association request primitive;
the lower layer management entity sends an association request message to the second multi-link device, the association request message includes the information of the at least two groups of links requesting to establish an association;
the lower layer management entity receives an association response message sent by the second multi-link device, the association response message includes an indication of whether the association is successfully established; and
the lower layer management entity sends a multi-link association confirmation primitive to the higher layer management entity, the multi-link association confirmation primitive includes the indication of whether the association is successfully established.

In some embodiments, in response to determining that the higher layer management entity determines that a mode for establishing the association with the second multi-link device is a multi-link conventional mode, association modes corresponding to links requesting to establish an association are set as the active modes, wherein the links requesting to establish an association are included in information of all links requesting to establish an association in the multi-link association request primitive; and in response to determining that the higher layer management entity determines that a mode for establishing the association with the second multi-link device is a multi-link power saving mode, association modes corresponding to links requesting to establish an association are set as the active modes, wherein the links requesting to establish an association are included in information of only one group of links requesting to establish an association in the multi-link association request primitive.

In some embodiments, before the higher layer management entity sends a multi-link association request primitive to the lower layer management entity, the method further includes:
the higher layer management entity sends a multi-link probe request primitive to the lower layer management entity, the multi-link probe request primitive includes the address of the second multi-link device, an identifier of a link having information required to be acquired, and an indication of the information required to be acquired;
the lower layer management entity sends a multi-link probe request message to the second multi-link device, the multi-link probe request message includes the identifier of the link having information required to be acquired, and an indication of the information required to be acquired;
the lower layer management entity receives a multi-link probe response message sent by the second multi-link device, the multi-link probe response message includes information of a requested link; and
the lower layer management entity sends a multi-link probe confirmation primitive to the higher layer management entity, the multi-link probe confirmation primitive includes acquired information of the link.

In some embodiments, the multi-link association request primitive further includes an identifier of a link recommended for sending the association request message, and the lower layer management entity sends the association request message to the second multi-link device on a link indicated by the identifier of the link recommended for sending the association request message.

In some embodiments, the multi-link probe request primitive further includes an identifier of a link recommended for sending the multi-link probe request message, and the lower layer management entity sends the multi-link probe request message to the second multi-link device on a link indicated by the identifier of the link recommended for sending the multi-link probe request message.

In some embodiments, the association modes further include a power saving mode, the power saving mode indicates that the link may be awakened to perform data transmission.

In some embodiments, after the lower layer management entity sends a multi-link association confirmation primitive to the higher layer management entity, the method further includes:
in response to determining that the indication of whether the association is successfully established indicates that the association is successfully established, the higher layer management entity sets an association mode corresponding to an associated link according to the information of the link requesting to establishing an association.

In some embodiments, the method further includes:
the higher layer management entity sets an association mode corresponding to at least one link in the sleep mode as an active mode; and
the lower layer management entity sends a first message to the second multi-link device, the first message at least includes information of a newly-added link in the active mode.

In some embodiments, a method for a higher layer management entity to determine a device required to be associated includes:
when the amount of buffer data to be sent is greater than a threshold, determine that the device required to be associated is the second multi-link device and that the mode for establishing the association with the second multi-link device is a multi-link conventional mode, otherwise determine that the device required to be associated is a single link device or the second multi-link device and that a mode for establishing the association with the second multi-link device is a multi-link power saving mode; alternatively,
when an index of a quality of service required by a type of service is single and it is determined that a single link device may satisfy the index according to acquired information of an associable device, determine that the device required to be associated is the single link device; when an index of a quality of service required by a type of service is single and it is determined that a single link device does not satisfy the index according to acquired information of an associable device, determine that the device required to be associated is the second multi-link device and that a mode for establishing the association with the second multi-link device is a multi-link conventional mode; and when an index of a quality of service required by a type of service has a wide span, determine that the device required to be associated is the second multi-link device and that a mode for establishing the association with the second multi-link device is a multi-link power saving mode; and alternatively,
when the first multi-link device has a power saving requirement, determine that the device required to be associated is a single link device or the second multi-link device and that a mode for establishing the association with the second multi-link device is a multi-link power saving mode; and when the first multi-link device does not have a power saving requirement, determine that the device required to be associated is the second multi-link device and that a mode for establishing the association with the second multi-link device is a multi-link conventional mode.

In a second aspect, the disclosure provides a multi-link device. The multi-link device includes a higher layer management entity and a lower layer management entity,
the higher layer management entity determines that a device required to be associated is a second multi-link device;
the higher layer management entity sends a multi-link association request primitive to the lower layer management entity, the multi-link association request primitive includes an address of the second multi-link device requesting to establish an association, and information of at least two groups of links requesting to establish an association, the information of the links requesting to establish an association includes identifiers of the links requesting to establish an association, and corresponding association modes, the association modes include an active mode and a sleep mode, the active mode indicates that the link may perform data transmission, the sleep mode indicates that the link may not perform data transmission, and association modes corresponding to links requesting to establish an association are set as active modes, which the links requesting to establish an association are included in information of at least one group of links requesting to establish an association in the multi-link association request primitive;
the lower layer management entity sends an association request message to the second multi-link device, the association request message includes the information of the at least two groups of links requesting to establish an association;
the lower layer management entity receives an association response message sent by the second multi-link device, the association response message includes an indication of whether the association is successfully established; and
the lower layer management entity sends a multi-link association confirmation primitive to the higher layer management entity, the multi-link association confirmation primitive includes the indication of whether the association is successfully established.

In a third aspect, the disclosure provides an electronic device. The electronic device includes a memory, a processor, and a computer program stored on the memory, where the processor implements the method in the first aspect when executing the computer program.

In a fourth aspect, the disclosure provides a non-transitory computer-readable storage medium, storing a computer program, where the computer program implements the method in the first aspect when executed by a processor.

In a fifth aspect, the disclosure provides a computer program product, including an instruction, where the instruction implements the method in the first aspect when executed by a processor.

It should be noted that the multi-link device in the second aspect, the electronic device in the third aspect, the storage medium in the fourth aspect, and the computer program product in the fifth aspect are configured for executing the method provided in the first aspect, so that the same beneficial effects as the method provided in the first aspect may be reached, which will not be repeated in the disclosure.

### BRIEF DESCRIPTION OF THE DRAWINGS

FIG. 1 is a schematic diagram of a relation between management entities included in a device in the prior art;

FIG. 2 is a schematic architecture diagram of a communication system according to the embodiments of the disclosure;

FIG. 3 is a schematic diagram of a method for establishing an association of a multi-link device according to the embodiments of the disclosure; and

FIG. 4 is a schematic structural diagram of an electronic device according to the embodiments of the disclosure.

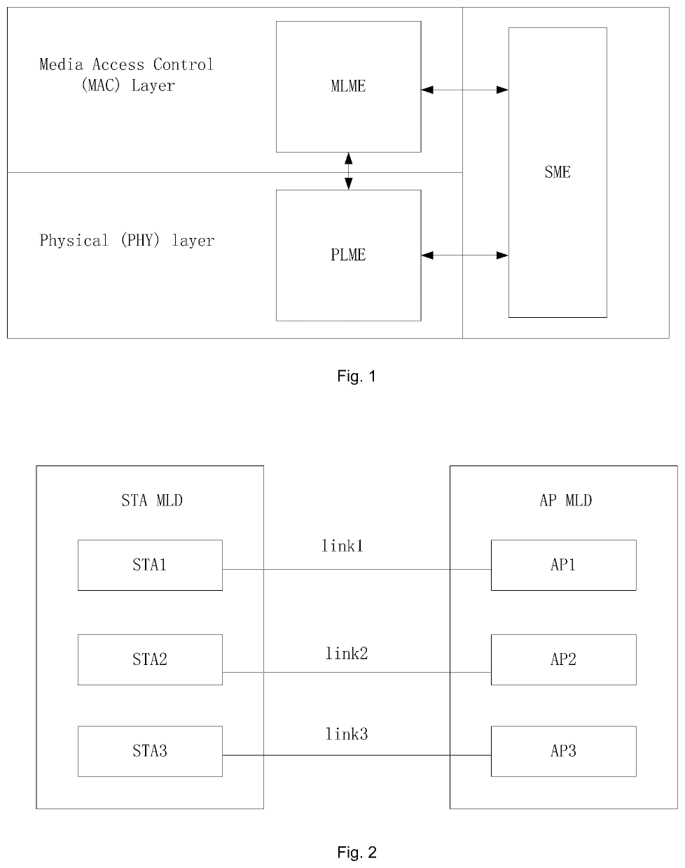

### DETAILED DESCRIPTION OF THE EMBODIMENTS

In order to enable those skilled in the art to better understand the technical solutions of the disclosure, the technical solutions in examples of the disclosure will be clearly and completely described below. Apparently, the described examples are merely some examples rather than all examples of the disclosure. It should be understood that the specific examples described herein are merely illustrative of the disclosure and are not intended to limit the disclosure. While the contents disclosed in the disclosure are described in accordance with one or more illustrative instances, it should be understood that all aspects of these disclosed contents can also form one complete technical solution independently. The following examples and features in the examples can be combined with one another without conflict.

In the examples of the disclosure, “at least one” means one or more, and “multiple” means two or more. In order to clearly describe the technical solutions in the examples of the disclosure, in the examples of the disclosure, the words “first”, “second”, etc. are employed to distinguish between the same or similar items with substantially the same functions and actions. Those skilled in the art can understand that the words “first”, “second”, etc. do not limit the quantity and execution order, but are only used for illustrating and distinguishing the described objects, without order, do not represent a particular limitation on the quantity of devices in the examples of the disclosure, and should not be interpreted as limiting the examples of the disclosure in any way.

In a multi-link scenario, typically, one physical device can include multiple logic devices, each of which can send and receive data and works on one link independently. When a multi-link device is associated with another multi-link device, for example, when a multi-link device station is associated with a multi-link device access point, an association is typically established on multiple links, and monitoring or data transmission is performed on the multiple links. The multiple links are activated at the same time, which will cause large power consumption of the device. Most of existing devices are battery-powered devices, and thus long-term use of the multiple links to perform data transmission will cause excessively rapid power consumption of a battery. In view of the above, the disclosure provides a method and device for establishing an association of a multi-link device, a electronic device, and a storage medium, so as to reduce power consumption of a battery.

FIG. 2 is a schematic structural diagram of a communication system according to the embodiments of the disclosure. As shown in FIG. 2, the communication system includes a multi-link device station (STA MLD) and a multi-link device access point (AP MLD). The STA MLD includes three logic stations STA1, STA2, and STA3. The multi-link device access point (AP MLD) includes three logic access points AP1, AP2, and AP3. The three logic access points AP1, AP2, and AP3 operate on three different links, respectively. In the example of the disclosure, it is assumed that AP1 operates on a link at 2.4 GHz, an identifier of the link is set as link1. AP2 operates on a link at 5 GHz, and an identifier of the link is set as link2. AP3 operates on a link at 6 GHz, and an identifier of the link is set as link3. The STA MLD internally includes a higher layer management entity (such as a station management entity (SME)) and a lower layer management entity (such as a media access control sublayer management entity (MLME)). The examples of the disclosure are described with the SME and the MLME as instances. The SME is responsible for logic control and management, parameter setting, etc. of the multi-link device station (STA MLD). The MLME is responsible for executing an operation on a media access layer and an operation indicated by the SME through primitive interaction with the SME, and feeding back acquired information to the SME.

It should be understood that FIG. 2 is merely a schematic architecture diagram of the communication system. The quantity, type, etc. of devices in the communication system are not limited in the embodiments of the disclosure. For example, the multi-link device station and the multi-link device access point can each include only two logic devices or four or more logic devices. The quantities of the logic devices in the multi-link device station and the multi-link device access point may be different. The multi-link device access point in FIG. 2 may also be the multi-link device station. In addition, those skilled in the art will understand that the term “access point (AP)” according to the disclosure can also be used for describing an access port or any other devices which can receive and transmit radio signals in a network architecture in accordance with the principles and functions described herein, and thus, the use of the access point is illustrative only

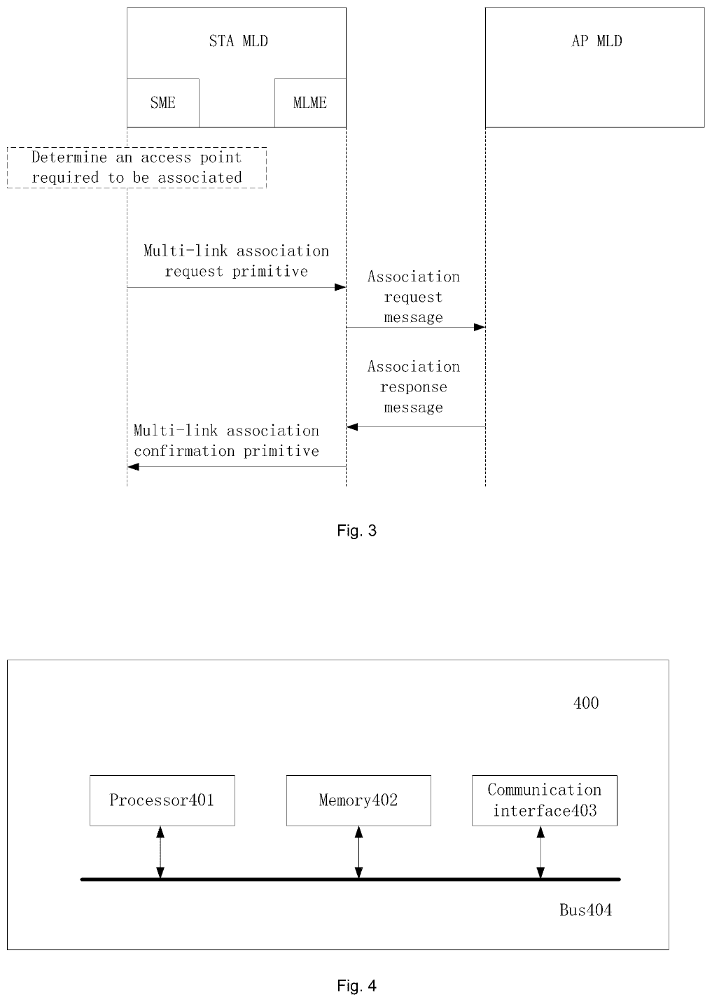

FIG. 3 is a schematic diagram of a method for establishing an association of a multi-link device according to the embodiments of the disclosure. As shown in FIG. 3, a method for establishing an association of a multi-link device includes:

301. An SME of an STA MLD determines an access point required to be associated according to its own strategy, for example, the amount of buffer data to be sent, a type of service to be performed, or its own power saving requirement. Illustratively, a method for an SME to determine an access point required to be associated includes any one or more of the following.

1) When the amount of buffer data to be sent is greater than a specific value S1, it is determined that an association with a multi-link device access point is established and that a mode for establishing the association with the multi-link device access point is a multi-link conventional mode, otherwise it is determined that an association with a single link device access point or the multi-link device access point is established and that a mode for establishing the association with the multi-link device access point is a multi-link power saving mode. S1 may be a preset threshold or a value set according to acquired information of the access point, for example, according to a transmission rate supported by the access point, or/and a supported coding mode, etc. It should be noted that a method for acquiring information of an access point may refer to the related prior art, and a method for acquiring information of an access point is illustratively provided below.

1001: an SME of an STA MLD sends a multi-link scan request primitive (such as an MLME-SCAN.request primitive) to an MLME, so as to request to acquire the information of the access point in an active or passive manner. In the active manner, the MLME sends a probe request message (such as a probe request message), and acquires the information of the access point by receiving a probe response message (such as a probe response message) upon response from the access point. In the passive manner, the MLME acquires the information of the access point by reading a beacon message (such as a beacon message) periodically sent by the access point.

1002: The MLME of the STA MLD sends a multi-link scan confirmation primitive (such as an MLME-SCAN.confirm primitive) to the SME, the primitive including the acquired information of the access point. The access points include a single link device access point and a multi-link device access point, the multi-link device access point including identifiers of multiple links operated by the multi-link device access point.

2) When an index of a quality of service required by a type of service is single and it is determined that the single link device access point may satisfy the index according to the acquired information of the access point, it is determined that an access point required to be associated is the single link device access point; when an index of a quality of service required by a type of service is single and it is determined that the single link device access point does not satisfy the index according to the acquired information of the access point, it is determined that an access point required to be associated is the multi-link device access point and that a mode for establishing an association with the multi-link device access point is a multi-link conventional mode; and when an index of a quality of service required by a type of service has a wide span, for example, a single link may satisfy a lower index, while a multi-link is required to satisfy a higher index, it is determined that an access point required to be associated is the multi-link device access point and that a mode for establishing an association with the multi-link device access point is a multi-link power saving mode.

3) When the STA MLD has a power saving requirement, it is determined that an association with the single link device access point or the multi-link device access point is established and that a mode for establishing an association with the multi-link device access point is a multi-link power saving mode; and when the STA MLD does not have a power saving requirement, it is determined that an association with the multi-link device access point is established and that a mode for establishing an association with the multi-link device access point is a multi-link conventional mode.

In the embodiments of the disclosure, the multi-link conventional mode means that a multi-link association with the multi-link device access point is established, and multiple associated links are all in active modes. The multi-link power saving mode means that a multi-link association with the multi-link device access point is established, but only one link is in an active mode and other links are in sleep modes.

In some embodiments, when the SME of the STA MLD determines that the access point required to be associated is the single link device access point, a process of establishing an association includes:
311. The SME of the STA MLD sends a multi-link association request primitive (such as an MLME-ASSOCIATE.request primitive) to the MLME, the primitive including the following parameters:
PeerSTAAddress: an address of the access point.
312. After receiving the multi-link association request primitive, the MLME of the STA MLD sends an association request message (such as an association request message) to an access point indicated by the PeerSTAAddress, so as to request to establish an association.
313. The MLME of the STA MLD receives an association response message (such as an association response message) sent by the access point, establishes an association with the access point, and sends a multi-link association confirmation primitive (such as an MLME-ASSOCIATE.confirm primitive) to the SME, so as to indicate that the association has been established.

In some other embodiments, the SME of the STA MLD determines that the access point required to be associated is the multi-link device access point and that the mode for establishing the association with the multi-link device access point is the multi-link conventional mode. In the embodiments, it is assumed that the SME determines that the access point required to be associated is an AP MLD, a process of establishing an association includes:
321. The SME of the STA MLD sends a multi-link association request primitive (such as an
MLME-ASSOCIATE.request primitive) to the MLME, the primitive including the following parameters:
ML element: information requesting to establish multiple links;
Recommended link: an optional parameter, recommending an identifier of a link for sending an association request message; and
PeerSTAAddress: an address of the multi-link device access point requesting to establish an association, which is set as an address of the AP MLD in the example.

The ML element includes at least two pieces of link info, each of which includes the following parameters:
Link identifier (ID): an identifier of a link requesting to establish an association;
PS mode: association modes corresponding to the link, the association modes including the active mode and the sleep mode, the active mode indicating that the link may perform data transmission, and the sleep mode indicating that the link may not perform data transmission. Optionally, the association modes may also include a power saving mode indicating that the link may be awakened to perform data transmission.

In the embodiments, it is assumed that the SME of the STA MLD determines that the links required to be associated are link1, link2, and link3. Since the multi-link conventional mode is selected, association modes of the three links required to be associated are all the active modes. The ML element included in the multi-link association request primitive includes three pieces of link info, such as link info 1, link info 2, and link info 3. Link info 1 includes the following parameters:
Link ID: an identifier of a link requesting to establish an association, which is set as link1 in the embodiments; and
PS mode: an association mode corresponding to the link, which is set as the active mode in the embodiments, indicating that the link is in the active mode after the association is established.
Link info 2 includes the following parameters:
Link ID: an identifier of a link requesting to establish an association, which is set as link2 in the example; and
PS mode: an association mode corresponding to the link, which is set as the active mode in the embodiments, indicating that the link is in the active mode after the association is established.
Link info 3 includes the following parameters:
Link ID: an identifier of a link requesting to establish an association, which is set as link3 in the embodiments; and
PS mode: an association mode corresponding to the link, which is set as the active mode in the embodiments, indicating that the link is in the active mode after the association is established.

322. After receiving the multi-link association request primitive, the MLME of the STA MLD sends an association request message (such as an association request message) to an access point indicated by the PeerSTAAddress, so as to request to establish an association. If the multi-link association request primitive includes the Recommended link, the MLME sends the association request message to the access point indicated by the PeerSTAAddress on the link indicated by the Recommended link. Illustratively, the association request message includes the following parameters:
ML element: information requesting to establish multiple links, which is set as in step 321.

323. After receiving the association request message, if the AP MLD agrees to establish the association, the PS mode corresponding to the link identifier (Link ID) in the ML element is checked; if the PS mode is the active mode, a mode corresponding to a logic station operating on the link in the STA MLD is set as active (for example, a mode corresponding to STA1 operating on link1 is set as active, a mode corresponding to STA2 operating on link2 is set as active, and a mode corresponding to STA3 operating on link3 is set as active), and successful association establishment is indicated in the association response message (such as an association response message); and if the AP MLD does not agree to establish the association, unsuccessful association establishment is indicated in the association response message. The AP MLD sends an association response message to the STA MLD.

324. The MLME of the STA MLD receives the association response message (such as an association response message) sent by the AP MLD, the message including an indication of whether the association is successfully established, and sends a multi-link association confirmation primitive (such as an MLME-ASSOCIATE.confirm primitive) to the SME, the primitive including an indication of whether the association is successfully established.

If it is indicated that the association is successfully established, the SME of the STA MLD sets an association mode corresponding to an associated link according to the ML element. In the example, the STA MLD is associated with the AP MLD on link1, link2, and link3 separately, as shown in FIG. 2, and the association modes of link1, link2, and link3 are all the active modes. The STA MLD may send data through link1, link2, and link3, and the AP MLD may also send data to the STA MLD through link1, link2, and link3.

Alternatively, before instructing the MLME to establish an association with the AP MLD, the SME of the STA MLD further instructs the MLME to acquire relevant information of the AP MLD, so as to determine the links required to be associated and an association mode corresponding to each link according to the acquired information of the AP MLD. Illustratively, a method for acquiring information of an AP MLD includes:
1001. The SME of the STA MLD sends a multi-link probe request primitive (such as an MLME-MLPROBE. request primitive) to the MLME, the primitive including the following parameters:
PeerSTAAddress: an address of a multi-link device access point, which is set as an address of the AP MLD in the embodiments;
Link ID: an identifier of a link having information required to be acquired;
Complete profile: indicating whether complete information is required, for example, if it is set as 1, the complete information is required, and if it is set as 0, no complete information is required;
STA profile: the parameter is not included when Complete profile is set as 1; and the parameter includes a name list of information required to be acquired when Complete profile is set as 0; and
Recommended link: an optional parameter, recommending an identifier of a link for sending a multi-link probe request message.

It should be noted that there may be multiple Link IDs in the multi-link probe request primitive. When there are multiple Link IDs, each Link ID corresponds to one Complete profile and one STA profile (when Complete profile is set as 0).

1002. After receiving the multi-link probe request primitive, the MLME of the STA MLD sends a multi-link probe request message (such as an ML probe request message) to an AP MLD indicated by the PeerSTAAddress. If the multi-link probe request primitive includes the Recommended link, the MLME sends the multi-link probe request message to the AP MLD indicated by the PeerSTAAddress on the link indicated by the Recommended link. For example, in response to that the link indicated by the Recommended link is link1, the MLME of the STA MLD sends the multi-link probe request message to AP1 through STA1, so as to request the AP MLD to provide information of the indicated link.

The multi-link probe request message may include the following parameters:
Link ID: an identifier of a link having information required to be acquired;
Complete profile: indicating whether complete information is required, for example, in response to that it is set as 1, the complete information is required, and in response to that it is set as 0, no complete information is required;
STA profile: the parameter is not included when Complete profile is set as 1; and the parameter includes a name list of information required to be acquired when Complete profile is set as 0.
1003: The MLME of the STA MLD receives a multi-link probe response message (such as an ML probe response message) sent by the AP MLD, the message including the information of a requested link.
1004: The MLME of the STA MLD sends a multi-link probe confirmation primitive (such as an MLME-MLPROBE.confirm primitive) to the SME, the primitive including acquired information of the link.

In some other embodiments, the SME of the STA MLD determines that the access point required to be associated is the multi-link device access point and that the mode for establishing the association with the multi-link device access point is the multi-link power saving mode. In the embodiments, it is assumed that the SME determines that the access point required to be associated is an AP MLD, a process of establishing an association includes:
331. The SME of the STA MLD sends a multi-link association request primitive (such as an MLME-ASSOCIATE.request primitive) to the MLME, the primitive including the following parameters:
ML element: information requesting to establish multiple links;
Recommended link: an optional parameter, recommending an identifier of a link for sending an association request message; and
PeerSTAAddress: an address of the multi-link device access point requesting to establish an association, which is set as an address of the AP MLD in the embodiments.

The ML element includes at least two pieces of link info, each of which includes the following parameters:
Link ID: an identifier of a link requesting to establish an association;
PS mode: association modes corresponding to the link, the association modes including the active mode and the sleep mode, the active mode indicating that the link may perform data transmission, and the sleep mode indicating that the link may not perform data transmission. Alternatively, the association modes may also include a power saving mode indicating that the link may be awakened to perform data transmission.

In the embodiments, it is assumed that the SME of the STA MLD determines that the links required to be associated are link1, link2, and link3. Since the multi-link power saving mode is selected, the association mode of only one of the three links required to be associated is the active mode, and the association modes of the other two links are the sleep modes or the power saving modes. It is assumed that the association mode of link1 is set as the active mode, and the association modes of links 2 and 3 are set as the sleep modes. The ML element in the multi-link association request primitive includes three pieces of link info, such as link info 1, link info 2, and link info 3. Link info 1 includes the following parameters:
Link ID: an identifier of a link requesting to establish an association, which is set as link1 in the embodiments; and
PS mode: an association mode corresponding to the link, which is set as the active mode in the embodiments, indicating that the link is in the active mode after the association is established.
Link info 2 includes the following parameters:
Link ID: an identifier of a link requesting to establish an association, which is set as link2 in the embodiments; and
PS mode: an association mode corresponding to the link, which is set as the sleep mode in the embodiments, indicating that the link is in the sleep mode after the association is established.
Link info 3 includes the following parameters:
Link ID: an identifier of a link requesting to establish an association, which is set as link3 in the embodiments; and
PS mode: an association mode corresponding to the link, which is set as the sleep mode in the embodiments, indicating that the link is in the sleep mode after the association is established.

332. After receiving the multi-link association request primitive, the MLME of the STA MLD sends an association request message (such as an association request message) to an access point indicated by the PeerSTAAddress, so as to request to establish an association. In response to that the multi-link association request primitive includes the Recommended link, the MLME sends the association request message to the access point indicated by the PeerSTAAddress on the link indicated by the Recommended link. Illustratively, the association request message includes the following parameters:
ML element: information requesting to establish multiple links, which is set as in step 331.

333. After receiving the association request message, in response to that the AP MLD agrees to establish the association, the PS mode corresponding to the link identifier (Link ID) in the ML element is checked; in response to that the PS mode is the active mode, a mode corresponding to a logic station operating on the link in the STA MLD is set as active, and in response to that the PS mode is the sleep mode, a mode corresponding to a logic station operating on the link in the STA MLD is set as sleep (for example, a mode corresponding to STA1 operating on link1 is set as active, a mode corresponding to STA2 operating on link2 is set as sleep, and a mode corresponding to STA3 operating on link3 is set as sleep); in response to that the association modes further include the power saving mode, in response to that the PS mode corresponding to the link identifier (Link ID) in the ML element indicates the power saving mode, the mode corresponding to the logic station operating on the link in the STA MLD is set as power saving, and successful association establishment is indicated in the association response message (such as an association response message); and In response to that the AP MLD does not agree to establish the association, unsuccessful association establishment is indicated in the association response message. The AP MLD sends an association response message to the STA MLD.

334. The MLME of the STA MLD receives the association response message (such as an association response message) sent by the AP MLD, the message including an indication of whether the association is successfully established, and sends a multi-link association confirmation primitive (such as an MLME-ASSOCIATE.confirm primitive) to the SME, the primitive including an indication of whether the association is successfully established.

In response to that it is indicated that the association is successfully established, the SME of the STA MLD sets an association mode of an associated link according to the ML element. In the embodiments, the STA MLD is associated with the AP MLD on link1, link2, and link3, as shown in FIG. 2, and the association modes of link1, link2, and link3 are all the sleep modes. The STA MLD may send data through link1 instead of link2 and link3, and the AP MLD may send data to the STA MLD through link1 instead of link2 and link3.

Alternatively, in response to that the association modes include the power saving mode, when the SME of the STA MLD sets the association mode of the link as the power saving mode, the link may be awakened to perform data transmission. For example, the SME is awakened at a set periodic timing to read a beacon message, or awakened by the AP MLD to receive data, etc.

After the STA MLD is associated with the AP MLD, when the AP MLD has downlink data required to be sent to the STA MLD, the mode corresponding to the logic station on the associated link of the STA MLD is checked firstly. In response to that the mode is the active mode, the data are sent to the STA MLD on the link after acquiring a sending opportunity. If the mode is the sleep mode, no data are sent to the STA MLD on the link. Optionally, in response to that the association modes further include the power saving mode, when the mode corresponding to the logic station of the STA MLD is the power saving mode, the AP MLD sets a bit corresponding to an identifier of the STA MLD as 1 in service indication information of a beacon message on a corresponding link, indicating that downlink data are sent to the STA MLD.

Alternatively, when the STA MLD has a large number of data required to be sent or a higher delay requirement, or is not required to consider power saving, the SME of the STA MLD may set the association mode corresponding to at least one link in the sleep mode as the active mode, and instruct the MLME to send information of a newly-added link in the active mode to the AP MLD. In response to that the SME of the STA MLD sets the association mode corresponding to link2 as the active mode, the STA MLD may perform data transmission through link1 and link2, so as to improve a data transmission efficiency.

The embodiments of the disclosure further disclose a device for establishing an association of a multi-link device. The device is applied to a first multi-link device, the first multi-link device including a higher layer management entity and a lower layer management entity. The device includes an association component, the association component is configured for executing:
the higher layer management entity determines that a device required to be associated is a second multi-link device;
the higher layer management entity sends a multi-link association request primitive to the lower layer management entity, the multi-link association request primitive including an address of the second multi-link device requesting to establish an association, and information of at least two groups of links requesting to establish an association, the information of the links requesting to establish an association including identifiers of the links requesting to establish an association, and corresponding association modes, the association modes including an active mode and a sleep mode, the active mode indicating that the link may perform data transmission, the sleep mode indicating that the link may not perform data transmission, and association modes corresponding to links requesting to establish an association included in information of at least one group of links requesting to establish an association in the multi-link association request primitive being set as active modes;
the lower layer management entity sends an association request message to the second multi-link device, the association request message including the information of the at least two groups of links requesting to establish an association;
the lower layer management entity receives an association response message sent by the second multi-link device, the association response message including an indication of whether the association is successfully established; and
the lower layer management entity sends a multi-link association confirmation primitive to the higher layer management entity, the multi-link association confirmation primitive including the indication of whether the association is successfully established.

Alternatively, in response to determining that the higher layer management entity determines that a mode for establishing the association with the second multi-link device is a multi-link conventional mode, association modes corresponding to links requesting to establish an association included in information of all links requesting to establish an association in the multi-link association request primitive are all set as the active modes; and in response to determining that the higher layer management entity determines that a mode for establishing the association with the second multi-link device is a multi-link power saving mode, association modes corresponding to links requesting to establish an association included in information of only one group of links requesting to establish an association in the multi-link association request primitive are set as the active modes.

Alternatively, the association module is further configured to execute:
the higher layer management entity sends a multi-link probe request primitive to the lower layer management entity, the multi-link probe request primitive including the address of the second multi-link device, an identifier of a link having information required to be acquired, and an indication of the information required to be acquired;
the lower layer management entity sends a multi-link probe request message to the second multi-link device, the multi-link probe request message including the identifier of the link having information required to be acquired, and an indication of the information required to be acquired;
the lower layer management entity receives a multi-link probe response message sent by the second multi-link device, the multi-link probe response message including information of a requested link; and
the lower layer management entity sends a multi-link probe confirmation primitive to the higher layer management entity, the multi-link probe confirmation primitive including acquired information of the link.

Alternatively, the multi-link association request primitive further includes an identifier of a link recommended for sending the association request message, and the lower layer management entity sends the association request message to the second multi-link device on a link indicated by the identifier of the link recommended for sending the association request message.

Alternatively, the multi-link probe request primitive further includes an identifier of a link recommended for sending the multi-link probe request message, and the lower layer management entity sends the multi-link probe request message to the second multi-link device on a link indicated by the identifier of the link recommended for sending the multi-link probe request message.

Alternatively, the association modes also include a power saving mode, the power saving mode indicating that the link may be awakened to perform data transmission.

Alternatively, the association module is further configured to execute:

In response to determining that the indication of whether the association is successfully established indicates that the association is successfully established, the higher layer management entity sets an association mode corresponding to an associated link according to the information of the link requesting to establishing an association.

Alternatively, the association module is further configured to execute:
the higher layer management entity sets an association mode corresponding to at least one link in the sleep mode as an active mode; and
the lower layer management entity sends a first message to the second multi-link device, the first message at least including information of a newly-added link in the active mode.

Alternatively, a method for a higher layer management entity to determine a device required to be associated includes:
when the amount of buffer data to be sent is greater than a threshold, determine that the device required to be associated is the second multi-link device and that the mode for establishing the association with the second multi-link device is a multi-link conventional mode, otherwise determine that the device required to be associated is a single link device or the second multi-link device and that a mode for establishing the association with the second multi-link device is a multi-link power saving mode; alternatively,
when an index of a quality of service required by a type of service is single and it is determined that a single link device may satisfy the index according to acquired information of an associable device, determine that the device required to be associated is the single link device; when an index of a quality of service required by a type of service is single and it is determined that a single link device does not satisfy the index according to acquired information of an associable device, determine that the device required to be associated is the second multi-link device and that a mode for establishing the association with the second multi-link device is a multi-link conventional mode; and when an index of a quality of service required by a type of service has a wide span, determine that the device required to be associated is the second multi-link device and that a mode for establishing the association with the second multi-link device is a multi-link power saving mode; and alternatively,
when the first multi-link device has a power saving requirement, determine that the device required to be associated is a single link device or the second multi-link device and that a mode for establishing the association with the second multi-link device is a multi-link power saving mode; and when the first multi-link device does not have a power saving requirement, determine that the device required to be associated is the second multi-link device and that a mode for establishing the association with the second multi-link device is a multi-link conventional mode.

It should be understood that the device herein is embodied in the form of a functional module. The term “component” herein can refer to an application specific integrated circuit (ASIC), an electronic circuit, a processor (for example, a shared processor, a dedicated processor, a processor group, etc.) and a memory that are configured for executing one or more software or firmware programs, a consolidated logic circuit, and/or other suitable assemblies that support the described function. The device described above has functions for implementing corresponding steps in the method described above. The functions described above can be implemented through hardware or by hardware executing corresponding software. The hardware or software includes one or more components corresponding to the functions described above. In the embodiments of the disclosure, the device can also be a chip or a chip system, for example, a system on chip (SoC), which is not limited by the disclosure herein.

According to the disclosure, in a process of establishing the association of the multi-link device, according to an indication from the higher layer management entity, the lower layer management entity in the device sets one or more links to the active mode, and sets other links to the sleep mode or the power saving mode. For example, the higher layer management entity executes a power saving operation when selecting an association object or establishing an association with the association object according to factors such as a service and power of the device. Therefore, the power consumption of the battery of the device is reduced while ensuring the quality of service, thereby prolonging the battery life of the multi-link device. In addition, according to the disclosure, detailed information of the association object of the multi-link device is acquired in a multi-link probe process. Therefore, the higher layer management entity determines the link required to be associated and an association mode correspond to each link according to the acquired detailed information.

The embodiments of the disclosure further disclose an electronic device. FIG. 4 is a schematic structural diagram of an electronic device according to the embodiments of the disclosure. As shown in FIG. 4, the device 400 includes a processor 401, a memory 402, and a communication interface 403, where the processor 401, the memory 402, and the communication interface 403 communicate with one another through a bus 404, and the memory 402 stores instructions executable by the processor 401, the instructions being loaded and executed by the processor 401, so as to control the communication interface 403 to send and/or receive signals.

It should be understood that specifically, the device 400 may be the STA MLD or the AP MLD in the embodiments described above. Alternatively, the functions of the STA MLD or the AP MLD in the embodiments described above may be integrated into the device 400, and the device 400 may be configured to execute all steps and/or flows corresponding to the STA MLD or the AP MLD in the embodiments described above. Alternatively, the memory 402 may include a read only memory and a random access memory, and provides instructions and data for the processor 401. Some memories 402 may also include a non-volatile random access memory. For example, the memory 402 may also store information of a type of device. The processor 401 may be configured for executing the instructions stored in the memory 401, and when the processor 401 executes the instructions, the processor 401 may execute all the corresponding steps and/or flows in the method embodiments described above.

It should be understood that in the embodiment of the disclosure, the processor can be a central processing unit (CPU). The processor can also be another general-purpose processor, a digital signal processor (DSP), an application specific integrated circuit (ASIC), a field programmable gate array (FPGA), or another programmable logic device, a discrete gate or transistor logic device, a discrete hardware assembly, etc. The general-purpose processor can be a microprocessor, any conventional processor, etc.

During implementation, all the steps of the method described above can be completed through an integrated logic circuit of hardware or instructions in the form of software in the processor. The steps of the method disclosed in combination with the embodiments of the disclosure can be executed directly through a hardware processor, or by combining hardware and software modules in the processor with each other. The software module can be positioned in a storage medium mature in the art, such as a random access memory, a flash memory, a read-only memory, a programmable read-only memory, or an electrically erasable programmable memory, and a register. The storage medium is positioned in the memory. The processor executes the instructions in the memory, and completes the steps of the method described above in combination with the hardware of the processor, which will not be described in detail herein, so as to avoid repetition.

The embodiments described above can be implemented through software, hardware, firmware, or any random combination in all or in part. When implemented through the software, the embodiments described above can be implemented in the form of computer program products in all or in part. The computer program product includes one or more computer instructions or computer programs. When loaded and executed on a computer, the computer instructions or the computer programs generate the flows or functions in accordance with the embodiments of the disclosure. The computer can be a general-purpose computer, a special-purpose computer, a computer network, or another programmable device. The computer instructions can be stored in a computer-readable storage medium, or transmitted from one computer-readable storage medium to another computer-readable storage medium, for example, from one website, computer, server, or data center to another website, computer, server, or data center in a wired manner (for example, in an infrared, radio, microwave, etc. manner). The computer-readable storage medium can be any available medium that a computer can access, or an integrated server, data center, etc. including one or more available media. The available medium can be a magnetic medium (for example, a floppy disk, a hard disk, or a tape), an optical medium (for example, a digital video disk (DVD)), or a semiconductor medium. The semiconductor medium can be a solid state disk.

It should be understood that in all the embodiments of the disclosure, the numbers of all the processes described above do not mean the order of execution, and the order of execution of each process should be determined by its function and internal logic, and should not constitute any limitation on the implementation processes of the embodiment of the disclosure. The component illustrated as a separate component can be physically separated or not. The component shown as a module can be a physical module or not. That is, they can be positioned in one place, or distributed over multiple network modules. Some or all of the modules can be selected according to actual requirements to implement the solutions of the examples of the disclosure.

In several components disclosed by the disclosure, it should be understood that the disclosed device, apparatus, and method can be implemented in other ways. For example, the apparatus disclose described above is merely schematic. For example, division of the modules is merely division of logic functions. Other division methods can be employed during actual implementation. For example, one component or assembly can be divided into multiple components or assemblies. Alternatively, multiple components or assemblies can be combined or integrated into another system. Alternatively, some features can be omitted or cannot be executed. In addition, coupling, direct coupling, or communication association with respect to each other shown or discussed can be indirect coupling or communication association through some interfaces, apparatuses, or components, which can be electrical, mechanical, etc.

Those of ordinary skill in the art will appreciate that the components and algorithm steps of all the instances described in combination with the embodiments disclosed herein can be implemented through electronic hardware, or combinations of computer software and electronic hardware. Whether these functions are executed through hardware or software depends on specific applications of the technical solution and design constraints. Those skilled in the art can use different methods to implement the described functions for each particular application, but such implementation should not be interpreted to be beyond the scope of the disclosure.

What are described above are merely the embodiments of the disclosure, but the scope of protection of the disclosure is not limited thereto. Changes or substitutions which can be readily conceived by any person skilled in the art within the technical scope disclosed by the disclosure should all fall within the scope of protection of the disclosure. Therefore, the scope of protection of the disclosure should be defined by the scope of protection of the claims.

1. A method for establishing an association of a multi-link device, applied to a first multi-link device, the first multi-link device comprising a higher layer management entity and a lower layer management entity, wherein the method comprising:
determining, by the higher layer management entity, a device required to be associated as a second multi-link device;
sending, by the higher layer management entity, a multi-link association request primitive to the lower layer management entity, the multi-link association request primitive comprising an address of the second multi-link device requesting to establish an association, and information of at least two groups of links requesting to establish an association, the information of the links requesting to establish an association comprising identifiers of the links requesting to establish an association, and association modes corresponding to the links, the association modes comprising an active mode and a sleep mode, the active mode is used for indicating that the link can perform data transmission, the sleep mode is used for indicating that the link cannot perform data transmission, and association modes corresponding to links requesting to establish an association are set as active modes, wherein the links requesting to establish an association are comprised in information of at least one group of links requesting to establish an association in the multi-link association request primitive;
sending, by the lower layer management entity, an association request message to the second multi-link device, the association request message comprising the information of the at least two groups of links requesting to establish an association;
receiving, by the lower layer management entity, an association response message sent by the second multi-link device, the association response message comprising an indication of whether the association is successfully established; and
sending, by the lower layer management entity, a multi-link association confirmation primitive to the higher layer management entity, the multi-link association confirmation primitive comprising the indication of whether the association is successfully established.

2. The method for establishing the association of the multi-link device as claimed in claim 1, wherein in response to determining that the higher layer management entity determines that a mode for establishing the association with the second multi-link device is a multi-link conventional mode, association modes corresponding to links requesting to establish an association are set as the active modes, wherein the links requesting to establish an association are comprised in information of all links requesting to establish an association in the multi-link association request primitive; and in response to determining that the higher layer management entity determines that a mode for establishing the association with the second multi-link device is a multi-link power saving mode, association modes corresponding to links requesting to establish an association are set as the active modes, wherein the links requesting to establish an association are comprised in information of only one group of links requesting to establish an association in the multi-link association request primitive.

3. The method for establishing the association of the multi-link device as claimed in claim 1, wherein before the step of sending the multi-link association request primitive to the lower layer management entity, the method further comprises:
sending, by the higher layer management entity, a multi-link probe request primitive to the lower layer management entity, the multi-link probe request primitive comprising the address of the second multi-link device, an identifier of a link having information required to be acquired, and an indication of the information required to be acquired;
sending, by the lower layer management entity, a multi-link probe request message to the second multi-link device, the multi-link probe request message comprising the identifier of the link having information required to be acquired, and an indication of the information required to be acquired;
receiving, by the lower layer management entity, a multi-link probe response message sent by the second multi-link device, the multi-link probe response message comprising information of a requested link; and
sending, by the lower layer management entity, a multi-link probe confirmation primitive to the higher layer management entity, the multi-link probe confirmation primitive comprising acquired information of the link.

4. The method for establishing the association of the multi-link device as claimed in claim 1, wherein the multi-link association request primitive further comprises an identifier of a link recommended for sending the association request message, and the lower layer management entity sends the association request message to the second multi-link device on a link indicated by the identifier of the link recommended for sending the association request message.

5. The method for establishing the association of the multi-link device as claimed in claim 3, wherein the multi-link probe request primitive further comprises an identifier of a link recommended for sending the multi-link probe request message, and the lower layer management entity sends the multi-link probe request message to the second multi-link device on a link indicated by the identifier of the link recommended for sending the multi-link probe request message.

6. The method for establishing the association of the multi-link device as claimed in claim 1, wherein the association modes further comprise a power saving mode, the power saving mode is used for indicating that the link can be awakened to perform data transmission.

7. The method for establishing the association of the multi-link device as claimed in claim 1, wherein after the step of sending the multi-link association confirmation primitive to the higher layer management entity, the method further comprises:
in response to determining that the indication of whether the association is successfully established indicates that the association is successfully established, the higher layer management entity sets an association mode corresponding to an associated link according to the information of the link requesting to establishing an association.

8. The method for establishing the association of the multi-link device as claimed in claim 7, further comprises:
setting by the higher layer management entity, an association mode corresponding to at least one link in the sleep mode as the active mode; and
sending by the lower layer management entity, a first message to the second multi-link device, the first message at least comprising information of a newly-added link in the active mode.

9. The method for establishing the association of the multi-link device as claimed in claim 1, wherein a method for the higher layer management entity to determine a device required to be associated comprises:
when the amount of buffer data to be sent is greater than a threshold, determining that the device required to be associated is the second multi-link device and that the mode for establishing the association with the second multi-link device is a multi-link conventional mode, otherwise determining that the device required to be associated is a single link device or the second multi-link device and that a mode for establishing the association with the second multi-link device is a multi-link power saving mode; alternatively,
when an index of a quality of service required by a type of service is single and it is determined that a single link device can satisfy the index according to acquired information of an associable device, determining that the device required to be associated is the single link device; when an index of a quality of service required by a type of service is single and it is determined that a single link device does not satisfy the index according to acquired information of an associable device, determining that the device required to be associated is the second multi-link device and that a mode for establishing the association with the second multi-link device is a multi-link conventional mode; and when an index of a quality of service required by a type of service has a wide span, determining that the device required to be associated is the second multi-link device and that a mode for establishing the association with the second multi-link device is a multi-link power saving mode; and alternatively,
when the first multi-link device has a power saving requirement, determining that the device required to be associated is a single link device or the second multi-link device and that a mode for establishing the association with the second multi-link device is a multi-link power saving mode; and when the first multi-link device does not have a power saving requirement, determining that the device required to be associated is the second multi-link device and that a mode for establishing the association with the second multi-link device is a multi-link conventional mode.

10. A multi-link device, comprising a higher layer management entity and a lower layer management entity, wherein
the higher layer management entity is configured to determine, a device required to be associated as a second multi-link device;
the higher layer management entity is configured to send a multi-link association request primitive to the lower layer management entity, the multi-link association request primitive comprising an address of the second multi-link device requesting to establish an association, and information of at least two groups of links requesting to establish an association, the information of the links requesting to establish an association comprising identifiers of the links requesting to establish an association, and association modes corresponding to the links, the association modes comprising an active mode and a sleep mode, the active mode is used for indicating that the link can perform data transmission, the sleep mode is used for indicating that the link cannot perform data transmission, and association modes corresponding to links requesting to establish an association are set as active modes, wherein the links requesting to establish an association are comprised in information of at least one group of links requesting to establish an association in the multi-link association request primitive;
the lower layer management entity is configured to send an association request message to the second multi-link device, the association request message comprising the information of the at least two groups of links requesting to establish an association;
the lower layer management entity is configured to receive an association response message sent by the second multi-link device, the association response message comprising an indication of whether the association is successfully established; and
the lower layer management entity is configured to send a multi-link association confirmation primitive to the higher layer management entity, the multi-link association confirmation primitive comprising the indication of whether the association is successfully established.

11. The multi-link device as claimed in claim 10, wherein in response to determining that the higher layer management entity determines that a mode for establishing the association with the second multi-link device is a multi-link conventional mode, association modes corresponding to links requesting to establish an association are set as the active modes, wherein the links requesting to establish an association are comprised in information of all links requesting to establish an association in the multi-link association request primitive; and in response to determining that the higher layer management entity determines that a mode for establishing the association with the second multi-link device is a multi-link power saving mode, association modes corresponding to links requesting to establish an association are set as the active modes, wherein the links requesting to establish an association are comprised in information of only one group of links requesting to establish an association in the multi-link association request primitive.

12. An electronic device, comprising a memory, a processor, and a computer program stored on the memory, wherein the processor implements the method as claimed in claim 1 when executing the computer program.

13. A non-transitory computer-readable storage medium, storing a computer program, wherein the computer program implements the method as claimed in claim 1 when executed by a processor.

14. The multi-link device as claimed in claim 10, wherein before the higher layer management entity sending the multi-link association request primitive to the lower layer management entity,
the higher layer management entity is configured to send a multi-link probe request primitive to the lower layer management entity, the multi-link probe request primitive comprising the address of the second multi-link device, an identifier of a link having information required to be acquired, and an indication of the information required to be acquired;
the lower layer management entity is configured to send a multi-link probe request message to the second multi-link device, the multi-link probe request message comprising the identifier of the link having information required to be acquired, and an indication of the information required to be acquired;
the lower layer management entity is configured to receive a multi-link probe response message sent by the second multi-link device, the multi-link probe response message comprising information of a requested link; and
the lower layer management entity is configured to send a multi-link probe confirmation primitive to the higher layer management entity, the multi-link probe confirmation primitive comprising acquired information of the link.
